(19) United States
(12) Patent Application Publication
(10) Pub. No.: US 2008/0265041 A1
(43) Pub. Date: Oct. 30, 2008

(54) Bar code blocking system

(76) Inventors: David Brophy, Mallow (IE); Peter L. Samaras, Woodstock, IL (US); Francisco Marin Domene, Barcelona (ES); Joel A. Richardson, Naperville, IL (US)

Correspondence Address: Kevin D. Erickson;Pauley Petersen & Erickson, Suite 365, 2800 West Higgins Road, Hoffman Estates, IL, 60169, US

(21) Appl. No.: 11/799,054

(22) Filed: Apr. 30, 2007

(51) Int. Cl. G06K 19/06

(52) U.S. Cl. 235/494

(57) ABSTRACT

A system and apparatus for ensuring a proper bar code scan on a multi-package of containers includes overcoating bar codes on each respective container with a dye and applying a unitizing carrier to the containers. The containers may also be oriented so that a bar code on each container is not readable by a bar code scanner.

### BACKGROUND OF THE INVENTION

1. Field of the Invention

This invention relates to a system for ensuring proper bar code scanning of containers in a multi-package.

2. Description of Prior Art

Conventional container carriers are often used to unitize a plurality of similarly sized containers, such as cans, bottles, jars and boxes and/or similar containers. Flexible plastic ring carriers are one such conventional container carrier.

Such flexible plastic ring carriers for cans and bottles may or may not have labels printed on the carrier. Often it is desirable to add a Universal Product Code (UPC) or “bar code” (the terms “UPC” and “bar code” are used interchangeably herein) to the container to identify individual containers and the carrier to identify the multi-container package, or multi-package. Containers within the multi-package that are individually coded with the bar code enable a bar code scanner or reader (also used interchangeably herein) to read product information, such as price.

Flexible plastic ring carriers may be used to unitize groups of four, six, eight, twelve or other suitable groups of containers into a convenient multi-package. In such cases, it is preferable to block any bar code on the individual container from the bar code reader. This will prevent the bar code for individual containers from being read in place of or in addition to the bar code for the multi-pack. When such containers are placed within a multi-package such as a “six pack,” difficulties may arise when container bar codes with individual container information are scanned instead of package bar codes with the information relevant to the multi-package or six pack.

Traditional multi-packages, such as six-packs, include containers that are positioned in random rotational orientations within the carrier. Each container generally includes an individual bar code which includes information, such as price, regarding the individual container. However, when the bar code for the individual container is scanned as the multi-package price, problems may arise for the vendor. Such problems primarily include a single container price being charged for a multi-container package and the inventory control problems that may result.

As such, it is desirable to ensure that the correct bar code is scanned for the correct container and/or multi-package. More specifically, it may be desirable to block the bar codes of individual containers within a multi-package from the scanning process.

### SUMMARY OF THE INVENTION

The present invention is directed to a system for blocking bar codes of individual containers within a multi-package.

According to a preferred embodiment of this invention, containers are rotationally oriented so that a bar code of each individual container faces a desired direction. Preferably, two rows of containers are each oriented in this manner so that the bar code of each container faces the bar code of each adjacent container.

The bar codes of each individual container are next preferably printed or otherwise overcoated with a blocking dye, ink or similar coating. The plurality of containers, such as cans, are next preferably positioned within a carrier to form the multi-package.

Accordingly, the plurality of containers are positioned in the carrier so that each bar code is blocked by either the coating and/or the containers are oriented in a rotationally inward position toward a center of the package and preferably toward an area of the carrier that is not readily accessible by a bar code reader. As a result, a bar code reader is less likely to read the bar code on each container.

### BRIEF DESCRIPTION OF THE DRAWINGS

The above-mentioned and other features and objects of this invention will be better understood from the following detailed description taken in conjunction with the drawings wherein:

FIG. 1 is a side view of a multi-package of containers assembled in a conventional manner with individual bar codes in random rotational orientations;

FIG. 2 is a schematic view of a typical bar code reader;

FIG. 3 is a side view of a container according to one preferred embodiment of this invention;

FIG. 4 is a schematic view of a traditional UPC or bar code;

FIG. 5A is a schematic view of a bar code according to a preferred embodiment of this invention; and

FIG. 5B is a schematic view of the bar code shown in FIG. 5A as “viewed” by a bar code reader;

FIG. 6 is a top view of a schematic of a system according to a preferred embodiment of this invention; and

FIG. 7 is a graph showing absorption curves of various red absorbing dyes and fluorescence frequencies of two UV fluorescing dyes for use with preferred embodiments of this invention.

### DESCRIPTION OF PREFERRED EMBODIMENTS

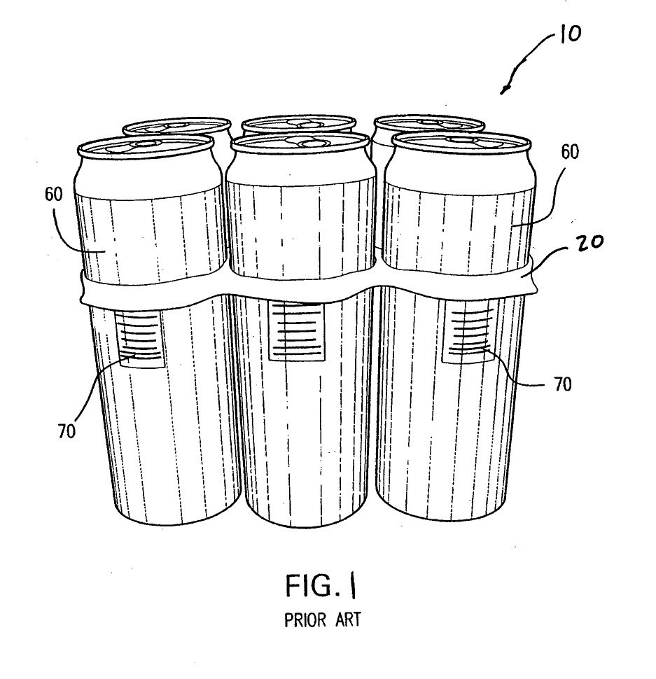

FIG. 1 shows a multi-package of six containers 60 unitized in a carrier to form a multi-packaging device. As shown, an exterior face of each container 60 includes an unobstructed, machine readable universal product code (“UPC”), referred to herein as bar code 70, printed thereon. Bar code 70 on each individual container 60 permits container 60 to be scanned by a bar code reader or scanner. When bar code 70 on container 60 is scanned by the bar code reader, information, such as the price, about the individual container 60 is retrieved from a computer connected with respect to the bar code reader. According to a preferred embodiment of this invention, the lines on bar code 70 are aligned in a generally horizontal orientation relative to container 60.

As shown in FIG. 1, a package of individual containers 60 comprises a unitized group of containers 60 sold as a multi-package 10. The unitized containers 60 are generally randomly oriented so that each container 60 is positioned in a different and/or random rotational orientation within the carrier. The package may have a separate bar code (not shown in FIG. 1) which allows information about the package, such as the price of the group of containers 60, to be retrieved when the separate bar code is scanned by the bar code reader. This separate “package” bar code may be printed on the exterior of the package or otherwise affixed to the package by suitable means, such as adhesive.

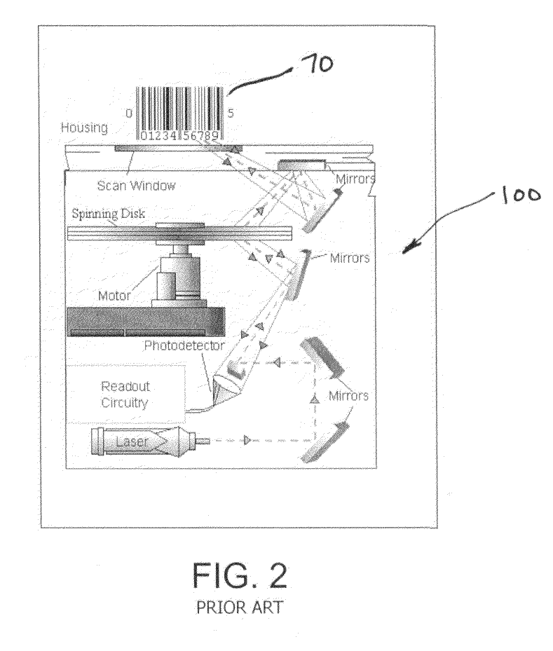

FIG. 2 shows a schematic of a conventional bar code scanner or reader 100. Bar code reader 100 traditionally uses laser light beams that are scanned across bar code 70 optically. In order to accept the broadest range of configurations, bar code readers 100 have been reported in the literature from wavelengths as low as 630 nm to 940 nm. Many point of sale bar code readers 100 fall in the range of 650 to 670 nm. The configuration of a typical point of sale bar code reader 100 is shown in FIG. 2. The laser beam is scanned across bar code 70 by moving the disk and/or the mirrors.

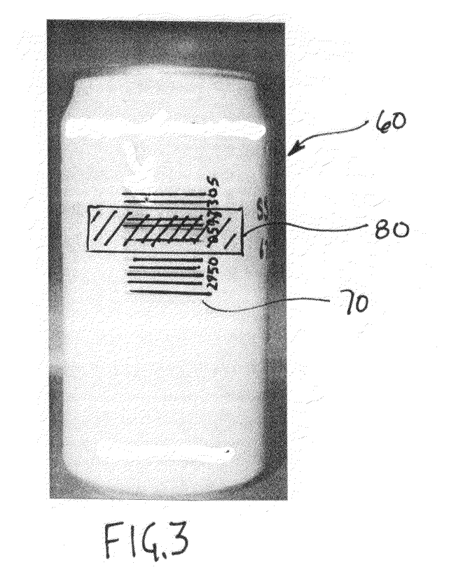

According to a preferred embodiment of this invention, bar code 70 is at least partially overprinted with coating 80, such as shown in FIG. 3. As described in more detail below, coating 80 preferably prevents bar code reader 100 from obtaining a proper or correct scan of bar code 70, thereby preventing incorrect scanning of multi-package 10.

One common wavelength for current bar code readers is 650 nm, not coincidentally, a common laser wavelength also used in CD players. The sensors for such bar code readers generally utilize a somewhat Narrow Band Pass (NBP) filter from 613 nm to 740 nm, which is generally most effective from about 640 nm to 710 nm. Based on this, the light from bar code reader 100 should be absorbed easily and/or it can be shifted outside the range that can be read by the sensors. In such a case, bar code 70 would be perceived as “black” to the reader even if human eyes perceive a normal appearing bar code.

An additional consideration in the development of the subject invention is the “error correcting” algorithms used by bar code reader manufacturers. The principal objective of such manufacturers is to provide successful scans of the bar code even if the bar code is defective or defaced. Therefore, if bar codes are overprinted over a portion or a part of the bars, the bar code reader may still correctly read the bar codes. On the other hand, if the bar codes are overprinted enough to eliminate a complete digit, conventional bar code readers will not try and “guess” the missing code. As a practical matter, enough of the bar code is preferably overprinted to eliminate one digit completely, but it may not be necessary or preferable to overprint the entire bar code. By limiting the amount of overprinting and by utilizing a transparent overprint that absorbs in the critical wavelength, the consumer will not readily perceive the overprinting, but the reading of the bar code should be effectively blocked.

It is preferable that the invention as described is compatible with standard bar codes used for retail sales in the US and Europe. These codes are known as UPC codes in the US and the related codes for Europe are know as EAN codes. UPC and EAN symbols are fixed in length, can only encode numbers, and are continuous symbologies using four element widths.

UPC version A symbols have 10 digits plus two overhead digits while EAN symbols have 12 digits and one overhead digit. The first overhead digit of a UPC version A symbol is a number related to the type of product while an EAN symbol uses the first two characters to designate the country of the EAN International organization issuing the number. UPC is in fact a subset of the more general EAN code. Scanners equipped to read EAN symbols can read UPC symbols as well. However, UPC scanners will not necessarily read EAN symbols.

Most barcodes in the US are 12-digit UPC (Universal Product Code) bar codes, with ten digits at the bottom of the code and one small number to each side. Bar codes are made up of both black and white lines. The white spaces in between the black lines are part of the code. There are four different thicknesses to the lines. Henceforth, the skinniest line will be referred to as “1,” the medium-sized line as “2,” the next largest line as “3.” and the thickest is “4.” Each UPC bar code begins and ends with 111 (thin black, thin white, thin black). In the very middle of the bar code, the 111, as well as the thin whites to either side, make up a 11111. Each UPC bar code that has 11111 will include two thin black lines sticking down between the numbers.

Additionally a new standard code, RSS (Reduced Space Symbology) and composite symbology are the latest bar code types for space-constrained identification from EAN International and the Uniform Code Council, Inc. RSS bar codes have been identified to solve problems in the grocery industry and in healthcare, where items are too small to allow for older bar code symbologies.

RSS bar codes include the following symbologies:
RSS-14: capable of encoding up to 20,000,000,000,000 (20 trillion) values. There are actually 15 characters that make up the barcode, but only 14 characters are encoded.
RSS-14 Truncated: has the exact same data characteristics as the Standard RSS-14 bar code, except the bar height is set to the RSS standard of 13 times the X dimension.
RSS-14 Stacked: has the exact same data characteristics as the Standard RSS-14 bar code. The data to encode is split in half and encoded as a split level bar code. This format is used if the width of the bar code will be an issue.
RSS-14 Stacked Omni-Directional: has the exact same data characteristics as the Standard RSS-14 bar code. The data to encode is separated to create a split level bar code. This symbology does not allow for human readable text with the bar code.
RSS-14 Limited: has the same data characteristics as the Standard RSS-14 bar code, except that it may only include values up to 4,000,000,000,000 (4 trillion).
RSS-14 Expanded: is a variable length symbology capable of encoding up to 74 numeric or 41 alphabetic characters. This symbology does allow for the linkage flag, which determines if there is a 2D composite bar code associated with the linear bar code.

Bar codes 70, such as shown in FIG. 4, are generally read by sensing the contrast difference between the light and dark bars. GS1, the international organization that controls both the UPC code in the US and the EAN code for Europe, sets minimal contrast standards for proper reading. GS1 evolved from the Uniform Code Council and EAN International. Generally, if the difference in reflectance between the most reflective and the least reflective is less than 20% of the maximum, a bar code is considered unreadable.

According to a preferred embodiment of this invention, coating 80 either reduces the contrast between bars or, by completely absorbing the laser light, makes the bar code appear as a solid bar. Accordingly, it is not necessary that coating 80 cover the entire bar code 70, but preferably coating covers enough of bar code 70 to eliminate a complete digit from the code. In spite of the number of different codes used for point-of-sale (POS) marking, each bottling line or packaging line generally handles only a limited number of codes and configurations. As a result, according to one preferred embodiment of this invention, printers and/or print heads for use with this invention may be configured to overprint bar code 70 with coating 80.

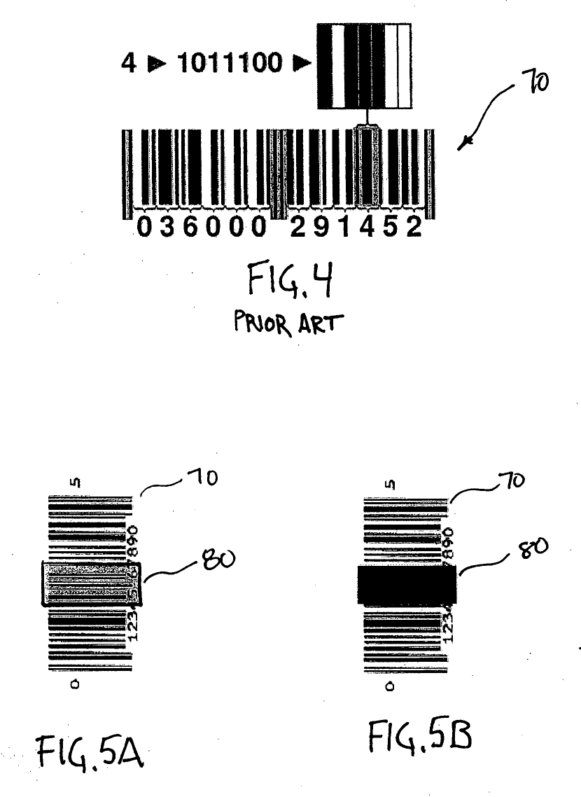

In a preferred embodiment of this invention, coating 80, such as overprinting, is printed across bar code 70 graphic, i.e., parallel to the bars, rather than along a length of bar code 70. FIG. 5A shows a preferably overprinted bar code 70 having coating 80. As contrasted with FIG. 5B, coating 80 appears semi-transparent to a consumer, but would appear as a solid bar to bar code reader 100.

According to a preferred embodiment of this invention, red dyes are identified and used that absorb the light at about 670 nm. Although traditionally referenced as an infrared absorber, such dyes are in fact visible light in the red region. Although various dyes absorb a significant amount of light in the proper wave band, such dyes do not consistently prevent a read of bar code 70. Additionally, the removal of red light from the generally transparent plastic material resulted in a light blue cast to bar codes 70 on containers 60.

Suitable coating 80 for use with blocking the bar codes 70 on individual containers 60 may include inks, dyes, tapes and/or similar overcoatings for placement on bar codes 70 of individual containers 60. Two such dyes include those from Exciton, Inc and Spectra Systems.

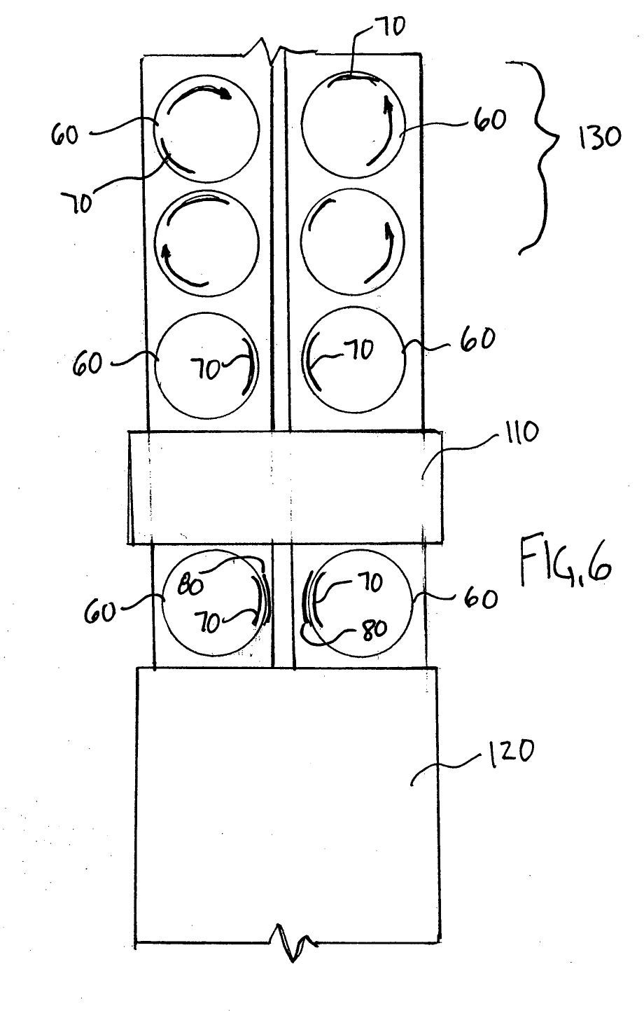

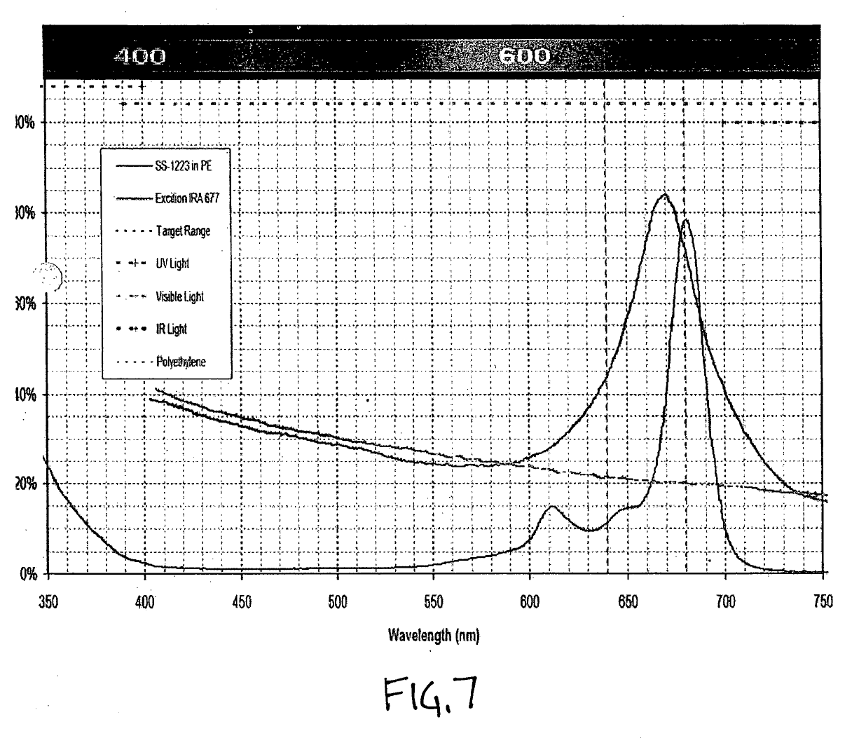

According to one preferred system, as shown schematically in FIG. 6, an orientation system 130 would additionally be utilized that would rotationally position each container 60 within multi-package 10, either before or after the application of coating 80. As shown in FIG. 6, it is preferably that such orientation occur before application of coating 80 so as to localize the necessary position or positions of printer 110. Such orientation would preferably position the UPC, EAN, or RSS bar code 70 for individual multi-packages 10 consistently on a side of container 60 away from a front and/or label side of container 60. Containers 60 would preferably enter an orientation and application system as they do now.

A preferable system according to this invention, such as shown in FIG. 6, having two generally parallel lanes of containers 60 would then orient containers 60 with the front of the label facing out and bar code 70 facing inward. After orientation, a printer 110 having a print head would overprint bar code 70 with coating 80 and application system 120, such as a conventional applicating drum known to those having ordinary skill in the art, would then apply the ringed carrier 20.

A suitable printer 110 may include a continuous ink jet print head for use in connection with the subject invention, such as the ITW Diagraph Linx 4900 Ultima together with a fast dry ink formulation suitable for the target package.

Accordingly, printer 110 may include the print head located between rows of containers 60 and two print heads may be required since the print rate of the current print heads are about one half that of the orientation system 130 and application system 120. This arrangement may be practical and beneficial since each print head can remain oriented in one direction.

Relevant to the use of a system as described is the drying time for the dye, ink or similar used as coating 80, the location of the bar code, the amount of bar code that must be covered, and the accuracy of the orientation system 130. Current positioning accuracy is ±⅜ inch so this is preferably included in the size of the printed area of coating 80. According to one preferred embodiment of this invention, the printed area of coating 80 would extend beyond the parameters of the bar code block. The extent of this overprinting may depend on the ability of the current generation of bar code scanners to read bar codes that are partially occluded. If a substantial section of bar code is unprinted or uncoated, less overprint may be necessary. Drying time for the ink, the location of the bar code, and the spacing required for the print heads are various factors that may govern the sequence of printing.

The absorbance characteristics for two representative dyes are shown in FIG. 7. Preferably, a suitable dye would be closely centered in a target range of approximately 640 nm to approximately 680 nm (indicated by dashed vertical lines in FIG. 6). According to a preferred embodiment of this invention, absorbing dyes are used rather than opaque dyes as customers generally indicate that a fully opaque overprint would be objectionable, but a transparent overprint may be acceptable, primarily from a marketing standpoint. Preferably, the overprinted or otherwise applied coating 80 would appear opaque to the bar code reader 100 but would appear as a tinted bar code 70 to the customer.

As described, problems and mis-scans may arise if the bar code reader 100 scans bar code 70 of the individual containers 60 in lieu of the separate package bar code. Such mis-scans may result in a single container 60 price being charged for a multi-container package.

FIG. 6 shows one preferred embodiment of this invention wherein each bar code 70 has been oriented into a preferably inward position relative to multi-package 10 although if coating 80 is applied in an effective manner over at least a portion of each respective bar code 70, specific orientation may not be required. Although cans are shown in FIGS. 1 and 6, bottles or any other commonly unitized container may be used in multi-package 10 according to this invention. Containers 60 are preferably, though not necessarily, like-sized within a single flexible carrier 10.

Each container carrier preferably includes a sheet having a width and length defining therein a plurality of container receiving apertures, each for receiving a single container 60. The plurality of container receiving apertures are preferably arranged in longitudinal rows and longitudinal ranks so as to form an array of container receiving apertures, such as two rows by three ranks for a six container multi-package, two rows by six ranks for a twelve container multi-package, etc.

The container carrier used in connection with the present invention is preferably substantially transparent and made of a suitable plastic material, preferably, generally transparent and preferably formed in extruded sheets, such as low to medium density polyethylene.

As shown schematically in FIG. 6, the plurality of containers 60 are rotationally oriented in the corresponding array of apertures so that each bar code 70 is positioned so that a bar code reader cannot scan each bar code 70. Although the inclusion of coating 80 may alone prevent bar code reader 100 from scanning bar codes 70, such orientation may provide additional security.

Various desirable methods of orienting individual containers 60 are taught by Arends et al., U.S. Pat. No. 6,484,478; Arends et al., U.S. Pat. No. 6,688,465; and Arends et al., U.S. Pat. No. 6,868,652, which are each incorporated herein by reference. As described in the Arends et al. Patents, incorporated herein be reference, each container 60 may be oriented before it is positioned within the carrier; after container 60 is positioned within the carrier or some combination of orienting containers 60 before and after engagement with the carrier. However, according to a preferred embodiment of the invention, containers 60 are oriented prior to both the overprinting step and the application step.

According to one preferred embodiment of this invention, a second bar code (or “multi-package code,” not shown) may be positioned on multi-package 10. The second bar code may include information regarding multi-package 10 including new pricing and quantity information.

While in the foregoing specification this invention has been described in relation to certain preferred embodiments thereof, and many details have been set forth for purpose of illustration, it will be apparent to those skilled in the art that package is susceptible to additional embodiments and that certain of the details described herein can be varied considerably without departing from the basic principles of the invention.

1. A system for avoiding an improper bar code read of a multi-package of containers, the system comprising:
applying a coating to at least a portion of a bar code of each container of the containers, wherein the coating includes a light absorbing dye;
applying a carrier to the containers; and
positioning the containers within the carrier so that the bar code of each container is not generally readable by a bar code scanner.

2. The system of claim 1 further comprising:
orienting a rotational position of the containers within the carrier.

3. The system of claim 2 further comprising:
orienting the rotational position of the containers within the carrier so that each bar code of each container faces a central area of the carrier.

4. The system of claim 2, wherein the step of orienting the rotational position of the containers is accomplished before applying the coating to at least the portion of the bar code.

5. The system of claim 1 wherein the light absorbing dye comprises a dye in the range of approximately 640 nm to approximately 680 nm.

6. The system of claim 1 wherein the light absorbing dye is generally transparent.

7. The system of claim 1 wherein the light absorbing dye comprises a red absorbing dye.

8. The system of claim 1 wherein the coating is positioned across at least one vertical bar on the bar code.

9. A method of assembling a plurality of containers in a multi-package so that a bar code on each container of the plurality of containers is not generally readable by a bar code reader, the method comprising:
orienting each container so that the bar code faces in a desired direction;
overcoating at least a portion of each individual bar code with a light absorbing dye; and
engaging the plurality of containers with a carrier so that the bar code of each container is not readable by the bar code reader.

10. The method of claim 9 further comprising:
following the step of orienting each container, maintaining the rotational position of each container until the carrier is applied.

11. (canceled)

12. The method of claim 9 further comprising: overcoating at least a single bar of each individual bar code.

13. (canceled)

14. The method of claim 9 wherein the dye is between approximately 640 nm and 680 nm.

15. The method of claim 9 further comprising the step of:
orienting two adjacent rows of containers so that the bar code of each container faces the bar code of each adjacent container.

16. A multi-package of containers in a carrier, each container of the containers including a bar code, the multi-package comprising:
a light absorbing coating printed over at least a portion of a bar code of each container of the containers so that the bar code of each container is not generally readable by a bar code scanner.

17. The multi-package of claim 16 wherein each container is rotationally oriented so that the bar code of each container faces a central portion of the multi-package.

18. The multi-package of claim 16 wherein a package bar code is printed on the carrier.

19. The multi-package of claim 16 wherein the coating is a light absorbing dye in the range of approximately 640 nm to approximately 680 nm.
